(19) United States
(12) Patent Application Publication
(10) Pub. No.: US 2024/0062764 A1
(43) Pub. Date: Feb. 22, 2024

(54) DISTRIBUTED SPEECH PROCESSING SYSTEM AND METHOD

(71) Applicant: ESPRESSIF SYSTEMS (SHANGHAI) CO., LTD., Shanghai (CN)

(72) Inventor: JIANXIN MAO, SHANGHAI (CN)

(21) Appl. No.: 18/260,196

(22) PCT Filed: Dec. 31, 2021
(86) PCT No.: PCT/CN2021/143983

§ 371 Date: Jun. 30, 2023

(30) Foreign Application Priority Data
Dec. 31, 2020 (CN) 202011628865.4

(51) Int. Cl. G10L 15/30; G10L 15/32

(52) U.S. Cl. CPC G10L 15/30; G10L 15/32

(57) ABSTRACT

A distributed speech processing system and a method therefor is provided. The system includes: a plurality of node devices in a network, wherein each node device includes a processor, a memory, a communication module and a sound processing module, and at least one node device comprises a sound acquisition module configured to acquire an audio signal; the sound processing module is configured to preprocess the audio signal to obtain a first sound preprocessed result; the communication module is configured to send the first sound preprocessed result to one or more node devices in the network; the communication module is further configured to receive one or more second sound preprocessed results from at least one other node device over the network; and the sound processing module is further configured to perform speech recognition based on the first sound preprocessed result and/or the one or more second sound preprocessed results.

### CROSS-REFERENCE TO RELATED APPLICATIONS

This application is the U.S. National Phase Application under 35 U.S.C. § 371 of International Patent Application No. PCT/CN2021/143983 filed on Dec. 31, 2021, which claims priority to Chinese Patent Application CN20201128865.4 filed on Dec. 31, 2020. The disclosures of the aforementioned applications are hereby incorporated by reference in their entireties.

### TECHNICAL FIELD

The present disclosure relates to the field of distributed speech processing technology, and in particular relates to a distributed speech processing system and method.

### BACKGROUND

Speech recognition technology and keyword recognition technology are becoming more and more mature and are being used more and more widely in the market. For example, children's toys, educational products, smart home and other products have added speech recognition functions to realize the function of sound interactive control.

There are currently two common approaches for speech recognition, where one is based on local recognition by a single device, and the other is based on local recognition combined with server-based cloud recognition.

For the first approach, a single device commonly used in the smart home market realizes local speech control. The speech recognition process is to collect original speech into a device, and perform calculations on this device to obtain the recognition result. During the implementation of this approach, if the user moves in the space environment or if it is needed to recognize speech across rooms, due to the limitation of the sound pickup distance, the speech recognition often cannot be successfully completed, resulting in failure to recognize speech or poor recognition effect.

For the second approach, speech recognition is usually performed through smart speakers or smart gateways and the like on the market. These devices serve as the control center and the only entrance for speech recognition. The devices must be connected to the Internet first, and then the corresponding cloud server to which the devices will access also needs to be connected to the Internet. These devices obtain the speech recognition results from the cloud, and then complete the speech recognition or the speech control. There are problems with this approach. For example, the failure of the device that serves as the only entry for speech recognition, or the fluctuation of the network, etc., will cause the problem of speech recognition failure. In particular, when the network stability is poor, it tends to cause slow recognition response. In addition, this type of speech recognition approach uploads the speech to the cloud, and the device needs to monitor the surrounding sound in the neighbor environment in real time, which can easily lead to user privacy and security issues.

At the same time, both approaches suffer from problems such as not being able to control speech recognition across rooms.

In addition to the above two approaches, there exists another local center recognition approach, which collects raw audio from multiple locations and transmits them to a central device for speech recognition. This approach can be used to solve problems such as short sound pickup distance, difficult recognition across rooms, and personnel movement. However, this approach relies heavily on the central device, and when the central device fails, it will cause the speech recognition function of the entire system to fail. Moreover, since the direct transmission of raw audio data poses high requirements on the network, the time delay of data transmission is large, and its actual recognition effect is not satisfactory.

Chinese patent publication (CN111415658A) discloses a decentralized speech-controlled multi-device system and a control method therefor. In its solution, a device first recognizes a wake-up word in the speech, and then sends the recognized wake-up word to all devices in the system, and receives wake-up words sent by other devices in the system. The device screens all the wake-up words, and screens out the wake-up words that match the present device. In this solution, if the speech received by the device contains a wake-up word (that is, a sound instruction) that it does not support, it may cause sound control to fail.

Chinese patent publication (CN110136708A) discloses a Bluetooth Mesh-based distributed speech control system and control method. The control system includes a Bluetooth Mesh network, speech controllers, and a Bluetooth node device. The speech controller includes a speech acquisition module, a speech noise reduction module, a speech recognition module, a Bluetooth module, and an optionally Wi-Fi module. The speech controllers communicate with each other via Bluetooth and keep the data synchronized in real time, and any of the speech controllers can control the Bluetooth node device in the network; the Bluetooth node device communicates with the speech controller via the Bluetooth Mesh network, and performs corresponding operations according to the received Mesh data or its own key-press events. In this solution, each speech controller acquires voice, performs speech noise reduction and echo cancellation, and then performs local or online speech recognition, and performs semantic understanding to parse out the information to be controlled, encapsulates the information into Mesh data, and sends the information to the Mesh network by the Bluetooth module. If the speech controller does not support the current control instruction, it may cause the device to fail to recognize the speech instruction it does not support, which eventually leads to speech control failure.

In summary, there is a need for an improved distributed speech processing solution in the existing art to solve the above-mentioned problems existing in the existing art. It should be understood that the technical problems listed above are only examples rather than limitations of the disclosure, and the disclosure is not limited to technical solutions that simultaneously solve all the above technical problems. The technical solutions of the disclosure can be implemented to solve one or more of the above or other technical problems.

### SUMMARY

In order to overcome the defects in the existing art, the present disclosure discloses a distributed speech processing system and a processing method therefor.

In one aspect of the present disclosure, a distributed speech processing system is provided, including a plurality of node devices forming a network, wherein each of the node devices includes a processor, a memory, a communication module, and a sound processing module, and at least one of the plurality of node devices includes a sound acquisition module; wherein,

the sound acquisition module is configured to acquire an audio signal;
the sound processing module is configured to preprocess the audio signal to obtain a first sound preprocessed result;
the communication module is configured to send the sound preprocessed results to one or more node devices in the network;
the communication module is further configured to receive one or more second sound preprocessed results from at least one other node device over the network; and
the sound processing module is further configured to perform speech recognition based on the first sound preprocessed result and/or the one or more second sound preprocessed results to obtain a first speech recognition result.

Preferably, the communication module is further configured to send the first speech recognition result to one or more node devices in the network.

Preferably, the communication module is further configured to receive one or more second speech recognition results from at least one other node device over the network.

Preferably, the sound processing module is further configured to perform speech recognition based on the first speech recognition result and the one or more second speech recognition results to obtain a final speech recognition result.

In another aspect of the present disclosure, a processing method for a distributed speech processing system is provided, executed by a node device in a network, and the method includes:

in response to that the node device includes a sound acquisition module, performing the following steps: acquiring an audio signal; preprocessing the audio signal to obtain a first sound preprocessed result; and sending the sound preprocessed result to one or more node devices in a Mesh network;
receiving one or more second sound preprocessed results from at least one other node device over the Mesh network; and
performing speech recognition based on the first sound preprocessed result and/or the one or more second sound preprocessed results.

Preferably, the processing method for the distributed speech processing system further includes: sending the first speech recognition result to one or more node devices in the network;

receiving one or more second speech recognition results from at least one other node device over the network; and
performing speech recognition based on the first speech recognition result and the one or more second speech recognition results to obtain a final speech recognition result.

The solution provided by this disclosure can extend the recognition distance without accessing the Internet, improve the recognition rate when people move, and easily realize cross-room sound control. Moreover, it can also bring speech recognition closer to user habits and make it more adaptable to real life scenarios.

In addition, the present disclosure performs distributed speech recognition through node devices in the network, and can realize speech recognition control over a long distance or across multiple rooms. The technical solution of the present disclosure enables each node device in the network to participate in the speech recognition process. On one hand, this solution realizes a decentralized design, thereby reducing recognition failures caused by key center node failures, and the design can enable the devices in the network to perform speech recognition in a concurrent manner, which can improve the efficiency of speech recognition. On the other hand, the information transmitted during the recognition process is sound preprocessed information, that is, non-raw audio data, so the bandwidth requirement of the network is not high and the stability of speech recognition is improved. By transmitting non-raw audio data, two advantages can be produced: firstly, compared to the speech recognition method that directly transmits raw data, the amount of data required for the transmission by the solution in the present disclosure is reduced; and secondly, compared to the speech recognition method that directly transmits recognition results, the solution in the present disclosure transmits the sound preprocessed results, which can avoid recognition failure caused by unsupported instructions, and improves the stability and robustness of speech recognition.

### BRIEF DESCRIPTION OF THE DRAWINGS

In the following, the present disclosure will be further explained on the basis of embodiments with reference to the attached drawings.

FIG. 1 schematically illustrates a block diagram of an embodiment of a distributed speech processing system according to the present disclosure.

FIG. 2 schematically illustrates a block diagram according to another embodiment of a distributed speech processing system of the present disclosure.

FIG. 3 schematically illustrates a block diagram of a node device according to an embodiment of a distributed speech processing system of the present disclosure.

FIG. 4 schematically illustrates a flow chart of an embodiment of a distributed speech processing method according to the present disclosure.

FIG. 5 schematically illustrates a flow chart of another embodiment of a distributed speech processing method according to the present disclosure.

FIG. 6 schematically illustrates a flow chart of a specific embodiment of a distributed speech processing method according to the present disclosure; and

FIG. 7 schematically illustrates a flow chart of another specific embodiment of a distributed speech processing method according to the present disclosure.

### DETAILED DESCRIPTION OF THE PREFERRED EMBODIMENTS

The distributed speech recognition processing system and the processing method therefor according to the present disclosure will be described in detail below with reference to the accompanying drawings and specific embodiments. It should be understood that the embodiments shown in the accompanying drawings and described hereinafter are merely illustrative and not intended to limit the disclosure. In addition, it should be understood that in this disclosure, ordinal words such as “first”, “second”, “third”, etc., unless explicitly specified or determined by the technical context, are used only to indicate different or identical elements in the technical solution, and do not imply any limitation on the order or importance of those elements.

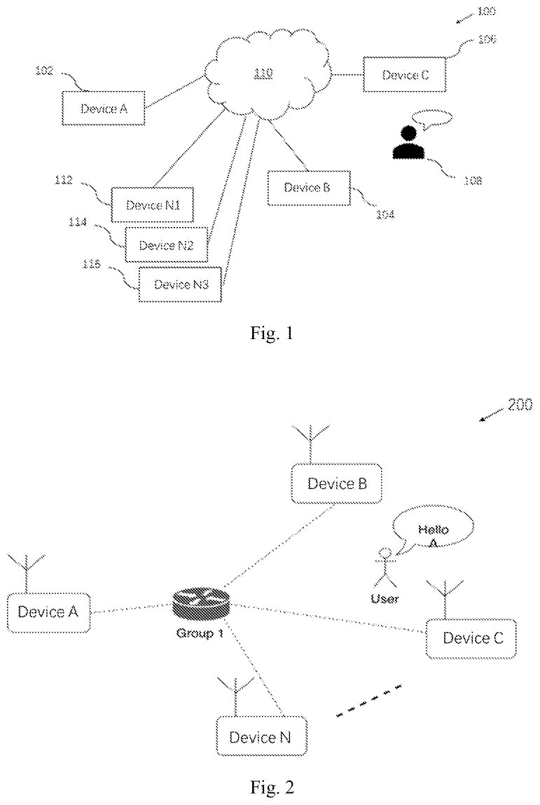

FIG. 1 illustrates a block diagram of an embodiment of a distributed speech processing system 100 according to the present disclosure, the system includes a plurality of node devices 102, 104, 106 and node devices 112, 114 and 116 in a network 110. It should be understood that the network 110 can be, for example, a wired, wireless and/or wired-wireless hybrid network for use in a home and/or an office, including but not limited to wireless networks commonly used in smart home scenarios. Various devices form the network 110, and can communicate with each other in a wired or wireless manner. Wherein, the wired manner can use communication approaches such as network cable or power line carrier, and the wireless approach can use Wi-Fi, BLE, Zigbee and other communication methods to realize network communication between various devices.

In a specific embodiment, each node device has the ability to connect to other node devices. Ad hoc networking can be performed between each node device to form an ad hoc network or a group network. Each device can also form a Mesh network among themselves, which allows any device node in the Mesh network to act as a router at the same time, that is, each node in the network can transmit and receive signals, and each node can communicate directly with one or more peer nodes.

FIG. 2 schematically illustrates a block diagram according to another embodiment of a distributed speech processing system 200 according to the present disclosure, wherein some of the node devices form a group such that the system of the present disclosure can also send messages to the group in a broadcast or multicast manner. It should be understood that the node devices can be in one or more groups, and the groups can be dynamic and user-definable, without requiring that the node devices between the groups must have a fixed hardware or communication connection relationship.

In the systems shown in FIG. 1 and FIG. 2, there can be different distances between a user and the node devices. For example, the user 108 is between a device B and a device C, and is within the speech pickup distance of the device B and the device C. However, the user 108 is far away from a device A and other devices, and speech signals from the user 108 cannot be received directly by the device A and other devices.

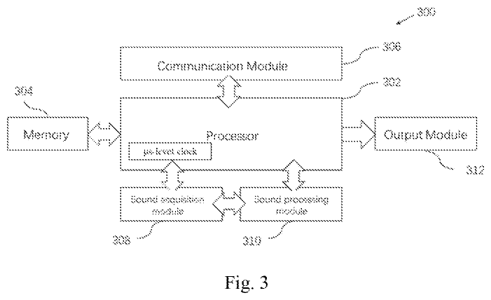

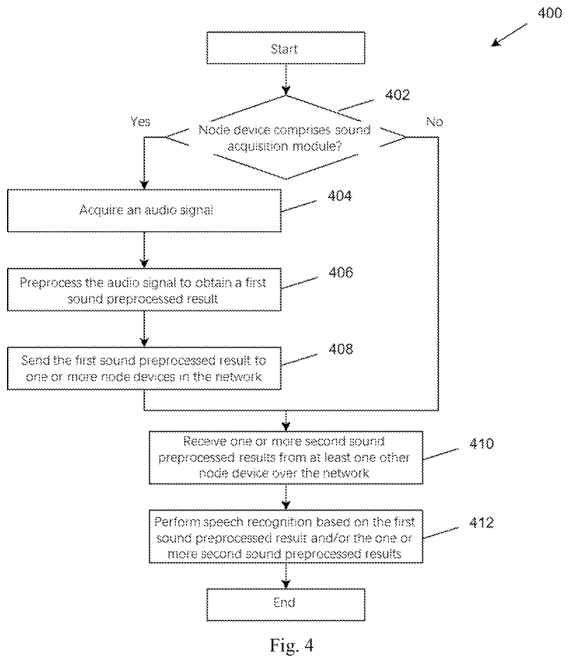

FIG. 3 schematically illustrates a block diagram of a node device 300 according to an embodiment of a distributed speech processing system according to the present disclosure. As shown in FIG. 3, each node device 300 may include a processor 302, a memory 304, a communication module 306, and a sound processing module 312. At least one of the plurality of node devices includes a sound acquisition module 308. Optionally, the node device 300 may also include an output module 312, where the processor 302 can provide a μs-level accurate clock. The communication module 306 can use any way of wired (for example, network cable/power line carrier, etc.) or wireless (for example, Wi-Fi/BLE/Zigbee, etc.) for networking communication with other devices. The memory 304 can record networking information and identification model parameters. The output module 312 may be, for example, a speaker, a switching device, etc. The sound acquisition module 308 may be, for example, a single microphone, a plurality of microphones, or an array of microphones.

The sound acquisition module 308 can be configured to acquire an audio signal. The sound processing module 310 can be configured to preprocess the audio signal to obtain a locally generated sound preprocessed result. The communication module 306 can be configured to send the locally generated sound preprocessed result to one or more node devices in the network 110. The communication module 306 can also be configured to receive one or more sound preprocessed results from at least one other node device from the network 110. It should be understood that in the context of this application, the locally generated sound preprocessed result can be referred to as a “first sound preprocessed result”, and the sound preprocessed result received from other node devices over the network can be referred to as a “second sound preprocessed result”. The sound processing module 310 can also be configured to perform speech recognition based on the locally generated sound preprocessed result and/or the one or more sound preprocessed results received over the network 110. In this manner, the node device 300 can obtain a locally generated speech recognition result.

The speech recognition performed by the sound processing module of the node device can include, but is not limited to, wake-up word detection, keyword recognition, continuous speech recognition, and the like. As a non-limiting example, the speech recognition result obtained by the sound processing module of the node device performing speech recognition can include a device identifier, a recognition result, a valid time of the recognition result, a recognition start time, and a sound quality. The first speech recognition result can also include instruction information and a device identifier, so as to instruct a target device to perform a corresponding operation.

In one or more embodiments, the distributed speech recognition scheme of the present disclosure can utilize sound preprocessed results generated locally and from the network on one hand, and speech recognition results generated locally and from the network on the other hand.

In an embodiment of the present disclosure, the node device of the present disclosure can arbitrate speech recognition results from different sources. As a non-limiting example, the communication module 306 can also be configured to send the locally generated speech recognition result to one or more node devices in the network. The communication module 306 is further configured to receive one or more speech recognition results from at least one other node device from the network. It should be understood that in the context of the present application, a locally generated speech recognition result can be referred to as a “first speech recognition result”, and a speech recognition result received from other node devices over the network can be referred to as a “second speech recognition result”. The sound processing module 310 is further configured to perform speech recognition based on the first speech recognition result and the one or more second speech recognition results to obtain a final speech recognition result. In addition, in a specific embodiment, the sound processing module 310 is further configured to perform weighting processing on the first speech recognition result and the one or more second speech recognition results to obtain a final speech recognition result.

For example, the sound processing module of the node device can be configured to assign weights based on the sound quality of each of the first speech recognition result and the one or more second speech recognition results, with the higher the sound quality the greater the assigned weight. As another example, the sound processing module of the node device can be configured to assign weights based on the source devices of the first speech recognition result and the one or more second speech recognition results. If the source device is the present node device, the assigned weight is greater.

In the context of the present disclosure, the sound preprocessed result is an intermediate result generated during the recognition process from the original speech to the speech recognition result. In a specific embodiment, each of the first sound preprocessed result and the one or more second sound preprocessed results includes a sound feature value, a sound quality and sound time information. In a specific embodiment, the communication module 306 of the node device receives one or more second sound preprocessed results from at least one other node device over the network, wherein the second sound preprocessed result includes a sound feature value, a sound quality, and sound time information, and may further include an incremental sequence number of the audio signal. Wherein, the sound feature value in the preprocessed result is an MFCC feature value or a PLP feature value of the audio signal. The sound quality may include a signal-to-noise ratio and an amplitude of the audio signal. The sound time information may include a start time and an end time of the audio signal. The sound time information may include the start time and a duration of the audio signal. Those skilled in the art should understand that the embodiments of the present disclosure are not limited thereto. Rather, those skilled in the art can adopt any suitable sound preprocessed results based on existing and future developed speech recognition and processing technologies to implement the solution of the present disclosure.

Those skilled in the art should understand that the preprocessing techniques applicable to the present disclosure may include, but are not limited to, signal framing, pre-emphasis, Fast Fourier Transform (FFT) and other preprocessing techniques. The preprocessing approach can obtain audio parameters based on the audio signal, generate a frequency domain signal or perform a Mel-Frequency Cepstral Coefficients (MFCC) algorithm or a Perceptual Linear Predictive (PLP) algorithm extraction for characterizing the content of the speech information.

In a specific embodiment, the sound processing module 310 of the node device is further configured to, for each of the first sound preprocessed result and the one or more second sound preprocessed results, determine whether the corresponding sound quality exceeds a predetermined threshold, and in response to that the corresponding sound quality does not exceed the predetermined threshold, discard the corresponding sound preprocessed result.

In a specific embodiment, the sound processing module 310 of the node device is further configured to select, among the first sound preprocessed result and the one or more second sound preprocessed results, one or more sound preprocessed results with the highest sound quality to perform speech recognition to obtain the first speech recognition result.

By way of example and not limitation, the first speech recognition result obtained by the sound processing module of the node device performing the speech recognition may include instruction information, where the instruction information is a specific value, such as 011, and the instruction information can be, for example, understood and executed by a node device that supports the corresponding instruction. In addition, the first speech recognition result obtained by the sound processing module of the node device performing sound recognition can include instruction information, wherein different node devices support different ranges of instruction information.

In addition, the sound processing module of the node device may further be configured to select, among the first sound preprocessed result and the one or more second sound preprocessed results, one or more sound preprocessed results with the highest sound quality for speech recognition to obtain the first speech recognition result.

In one embodiment, the sound processing module of the node device can determine whether the sound quality of the first sound preprocessed result exceeds a predetermined threshold, and in response to that the sound quality of the first sound preprocessed result exceeds a predetermined threshold, select the first sound preprocessed result for speech recognition to obtain the first speech recognition result.

As an example embodiment, the communication module of the node device can send the first speech recognition result to one or more node devices in the network by means of unicast, multicast and/or broadcast.

In one embodiment, for the first speech recognition result in which the device identifier in the first speech recognition result is inconsistent with the device identifier of the present node device, the first speech recognition result is sent to one or more node devices in the network by the communication module of the node device. Rather, for the first speech recognition result in which the device identifier in the first speech recognition result is consistent with the device identifier of the present node device, the first speech recognition result is not sent to the one or more node devices in the network.

In one embodiment, the sound processing module of the node device can determine the time validity of the obtained final speech recognition result, and if the valid time of the recognition result is expired, the corresponding operation corresponding to the recognition result will not be executed. In addition, the sound processing module of the node device can determine the device identifier for the obtained final speech recognition result, and if the device identifier is the present node device, the corresponding operation corresponding to the recognition result is performed.

As a non-limiting example, the sound processing module of the node device can determine the device identifier for the obtained final speech recognition result, and if the device identifier is the present node device, feedback information is output and sent to one or more other node devices in the network by the communication module.

In addition, the sound processing module of the node device can determine the device identifier for the obtained final speech recognition result, and if the device identifier is the present node device, feedback information is output, wherein the output feedback information includes at least a recognition time, a recognition result and a maximum value of the incremental sequence number.

FIG. 4 schematically illustrates a flow chart of an embodiment of a distributed speech processing method 400 according to the present disclosure. The distributed speech processing method is executed by a node device in the network. At step 402, it is determined whether the node device includes a sound acquisition module. If the node device includes a sound acquisition module, go to step 404. If the node device does not include a sound acquisition module, go to step 410. At step 404, an audio signal is acquired. At step 406, the audio signal is preprocessed to obtain a first sound preprocessed result. At step 408, the first sound preprocessed result is sent to one or more node devices in the network. At step 410, one or more second sound preprocessed results are received from at least one other node device over the network. At step 412, speech recognition is performed based on the first sound preprocessed result and/or the one or more second sound preprocessed results.

In one embodiment, each of the first sound preprocessed result and the one or more second sound preprocessed results can be determined as to whether the corresponding sound quality exceeds a predetermined threshold, and in response to that the corresponding sound quality does not exceed the predetermined threshold, the corresponding sound preprocessed result is discarded.

In another embodiment, one or more sound preprocessed results with the highest sound quality can be selected from the first sound preprocessed result and the one or more second sound preprocessed results to perform speech recognition to obtain the first speech recognition result.

As a non-limiting example, the method of the present disclosure can combine the local recognition result with recognition results from the network to obtain the final speech recognition result. For example, the node device can send the first speech recognition result to one or more node devices in the network. The node device can receive one or more second speech recognition results from at least one other node device over the network. The node device can perform speech recognition based on the first speech recognition result and the one or more second speech recognition results to obtain a final speech recognition result.

In another specific embodiment, a weighted average processing can be performed on the first speech recognition result and the one or more second speech recognition results to obtain the final speech recognition result.

In one or more embodiments, the solution of the present disclosure can be obtained by further concatenating fragments of sound preprocessed results generated locally and from the network.

In one embodiment, a distributed speech processing system is provided, including: a plurality of node devices forming a network, wherein each node device includes a processor, a memory, a communication module, and a sound processing module. At least one of the plurality of node devices includes a sound acquisition module configured to acquire an audio signal. The sound processing module is configured to preprocess the audio signal to obtain a first sound preprocessed result. The communication module is further configured to receive one or more second sound preprocessed results from at least one other node device over the network. Each of the first sound preprocessed result and the one or more second sound preprocessed results includes one or more data blocks; each of the one or more data blocks includes time information, and the time information identifies the time when the sound processing module completes the preprocessing of the data block. Each of the one or more data blocks further includes an incremental sequence number, which is assigned based on the time information in the data block. The sound processing module is further configured to concatenate the data blocks of the first sound preprocessed result and/or the one or more second sound preprocessed results in an increasing order according to the incremental sequence numbers to obtain a complete third sound preprocessed result. The sound processing module is further configured to process the third sound preprocessed result to obtain a final speech recognition result.

In one embodiment, the communication module is configured to send the first sound preprocessed result to one or more node devices in the network.

In one embodiment, each data block of the first and/or second sound preprocessed result is configured to have the same duration.

In one embodiment, the incremental sequence number is assigned to the data block when the sound processing module of each of the plurality of node devices preprocesses the audio signal.

In one embodiment, the incremental sequence number is assigned to a data block of the second sound preprocessed result after the sound processing module of each of the plurality of node devices receives the second sound preprocessed result from at least one other node device over the network.

In one embodiment, the sound processing module is configured to detect a time difference of the data blocks and assign the same incremental sequence number if the time difference is within a specified threshold.

In one embodiment, the sound processing module is configured to select the data block with the best sound quality from the data blocks with the same incremental sequence number for concatenating.

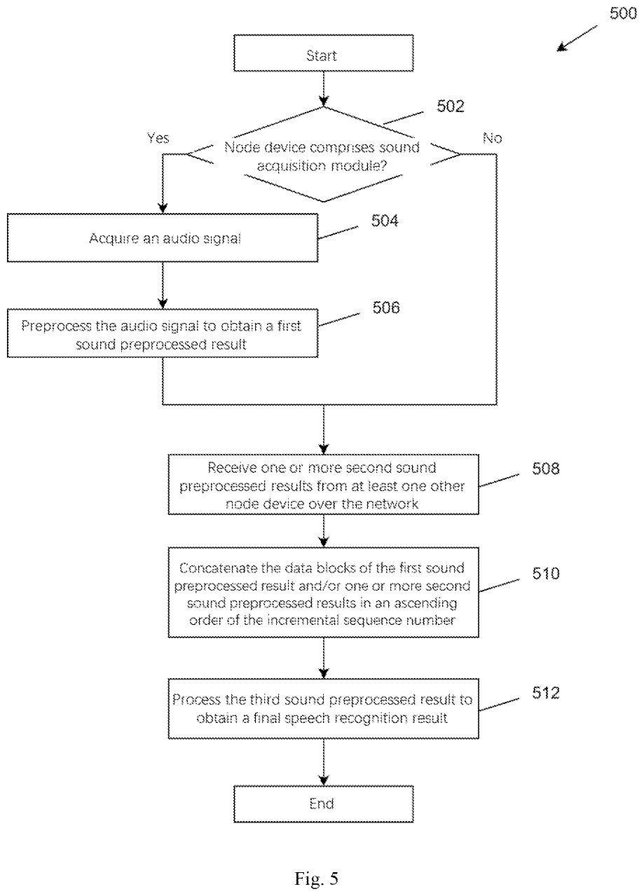

FIG. 5 schematically illustrates a flow chart of another specific embodiment of a distributed speech processing method 500 provided according to the present application. The method is executed by a node device in the network. At step 502, it is determined whether the node device includes a sound acquisition module. If the node device includes a sound acquisition module, go to step 504. If the node device does not include a sound acquisition module, go to step 508. At step 504, an audio signal is acquired. At step 506, the audio signal is preprocessed to obtain a first sound preprocessed result. At step 508, one or more second sound preprocessed results are received from at least one other node device over the network, wherein each of the first sound preprocessed result and the one or more second sound preprocessed results includes one or more data blocks, wherein each of the one or more data blocks includes time information, and the time information identifies the time when the sound processing module completes the preprocessing of the data block, and wherein each of the one or more data blocks further includes an incremental sequence number assigned based on the time information in the data block. At step 510, the data blocks of the first sound preprocessed result and/or the one or more second sound preprocessed results are concatenated in an ascending order of the incremental sequence numbers, so as to obtain a complete third sound preprocessed result. At step 512, the third sound preprocessed result is processed to obtain a final speech recognition result.

It should be understood that in the context of the present disclosure, the sound preprocessed result obtained by concatenating the data blocks of the first sound preprocessed result and/or the one or more second sound preprocessed results is referred to as the “third sound preprocessed result”.

In one embodiment, the distributed speech processing method further includes sending the first sound preprocessed result to the one or more node devices in the network.

In one embodiment, each data block of the first sound preprocessed result is configured to have the same duration.

In one embodiment, the incremental sequence number is assigned to a data block when the sound processing module of each of the plurality of node devices preprocesses the audio signal, wherein the incremental sequence number is assigned based on the time information.

In one embodiment, the incremental sequence number is assigned to a data block of the second sound preprocessed result after the sound processing module of each of the plurality of node devices receives the second sound preprocessed result from at least one other node device over the network, wherein the incremental sequence number is assigned based on time information.

In one embodiment, the sound processing module is configured to detect a time difference of the data blocks and assign the same incremental sequence number if the time difference is within a threshold.

In one embodiment, the sound processing module is configured to select the data block with the best sound quality from the data blocks with the same incremental sequence number.

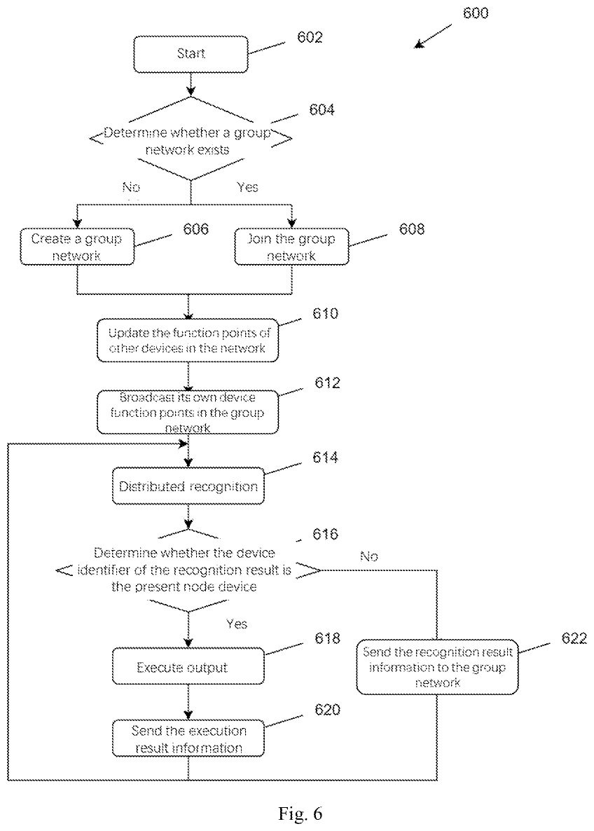

FIG. 6 schematically illustrates a flow chart of a specific embodiment of a distributed speech processing method 600 according to the present disclosure. In this embodiment, node devices perform ad hoc networking, establish a group, and enable each node device in the network to perform speech recognition and exchanging recognition information in the group, which may upgrade the original speech recognition performed by a single node device to a speech recognition system distributed on multiple node devices, thereby solving the problems of relying on a single control center or relying on a network server and not being able to cross regions, as well as insecure private information in the scenarios of speech recognition, keyword recognition, and speech control etc.

At step 604, it is determined whether a group network exists when the node device is powered on. If no group network exists, then at step 606, a group network is created. If a group network already exists, the group network is joined at step 608. After joining the group network, the node device first updates a function point of other device(s) in the network at step 610, to be informed of whether the function point supported by other device(s) in the network have been modified, and at the same time or later, the node device broadcasts its own device function point over the group network. It should be understood that in the context of the present disclosure, the “function point” is used to inform other node devices that join the group what input and output functions a device has. It should be understood that in the context of the present disclosure, the “group network” refers to a network formed by node devices that support broadcasting and/or multicasting, including but not limited to Wi-Fi, BLE and ZigBee networks with various topologies (such as Mesh topologies), and can also be wired, wireless or hybrid networks.

At step 614, the node device acquires a recognition result through distributed recognition, and at step 616, it is determined whether the device identifier of the recognition result is the present node device. If the device identifier is not the present node device, then the recognition information is sent at step 622. As a non-limiting example, the recognition information may include an identifier of the recognition device, a recognition time, a recognition result, and credibility of the recognition result. If the device identifier is the present device, the output is executed at step 618, and subsequently the execution result information is sent to other node devices in the network at step 620. As a non-limiting example, the execution result information may include a device identifier, a recognition time, a recognition result, an execution result, and the like.

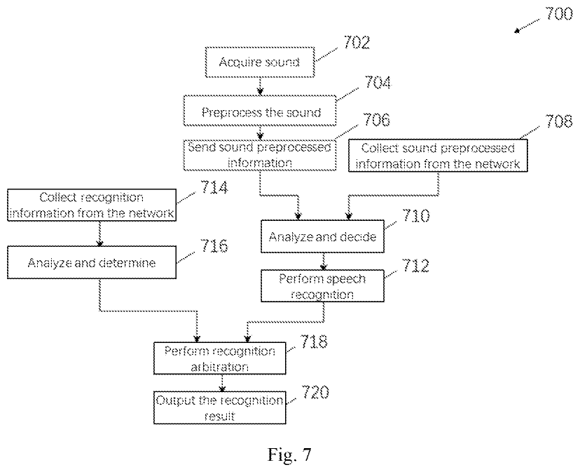

FIG. 7 schematically illustrates a flow chart of another specific embodiment of a distributed speech processing method according to the present application. As shown in FIG. 7, the distributed speech processing method in this embodiment may include three inputs and one output, and the three inputs are respectively: a sound acquired by a local microphone at step 702, and sound preprocessed information collected from the network at step 708, and speech recognition information collected from the network at step 714; and, the one output is the speech recognition result output at step 720.

In this embodiment, the distributed speech processing method 700 is divided into three stages: a preprocessing stage, an analysis decision stage, and a recognition arbitration stage.

In the preprocessing stage, the sound acquired by the local microphone is first preprocessed at step 704 to obtain preprocessed information, and then the preprocessed information is sent to the group network at step 706. The preprocessed information includes, for example, feature information of the acquired sound that can be used for recognition by a recognition model. The preprocessed information also includes, for example, information that can be used to evaluate sound quality, such as a signal-to-noise ratio and an amplitude of the acquired sound. The preprocessed information also includes, for example, an incremental sequence number of the preprocessed information. By way of example and not limitation, the preprocessed information can also include start time information and end time information.

In the analysis decision stage at step 710, the sound quality of the sound preprocessed information acquired from the network and the sound quality of the sound preprocessed information obtained locally are ranked, and the corresponding preprocessed information with the best sound quality is analyzed and screened out to be sent to a subsequent speech recognition step 712. At step 712, speech recognition is performed to output local recognition information. The local recognition information or the network recognition information can include, but are not limited to, one or more of the following: a recognition result, a device identifier of the speech recognition, a valid time of the recognition result, a recognition start time, and the sound quality.

In the recognition arbitration stage, the recognition information acquired from the network at step 714 is first analyzed and then determined at step 716, and expired information is removed according to the time validity of the recognition information. At step 718, recognition arbitration is then performed on the information obtained from step 716 together with the output of the local speech recognition at step 712. The recognition arbitration at step 718 is ranked according to the sound quality carried by each of the network speech recognition results and the local speech recognition results, so as to select a better speech recognition result to generate the final speech recognition result. For example, a specified number of speech recognition results with higher sound quality can be selected and weighted to obtain the final recognition result.

The principle of the present disclosure is further described by the following example scenarios. In the first scenario, referring to FIG. 2, the device A, the device B, and the device C are powered on sequentially. The device A is first powered on, and finds that no group network exists, so it creates a group network. After the device B and the device C are powered on, they find that the group network already exists, so they join the group network. After joining the group network, each of the device B and the device C first updates whether a function point of other device in the network (that is, the device A) has been modified, and at the same time broadcasts the function point of each of the present devices (that is, the device B and the device C) within the group to inform other node devices having joined the group of input and output functions of each of the present devices.

The user is located between the device B and the device C, and emits a speech signal. The device B and the device C can acquire the audio signal emitted by the user, while the device A cannot acquire the audio signal emitted by the user, because the distance between the device A and the user is farther than the sound pickup distance of the sound acquisition module of the device A.

Each of the device B and the device C preprocess the received audio signal, and the obtained preprocessed result includes at least sound feature information of the acquired audio signal that can be applied to a speech recognition model. The preprocessed result also includes information such as a signal-to-noise ratio and an amplitude of the acquired sound, which can be used to evaluate a sound quality. The preprocessed result also includes an incremental sequence number of the audio signal. As an example, the preprocessed data sent by the device B includes N data blocks, and each of the N data blocks includes an incremental sequence number. The preprocessed result also include start time information and end time information, and the start time information is used to distinguish different sound information.

The device B and the device C preprocess the acquired sound to obtain relevant preprocessed information and send to the network. A communication module of the device A further receives the sound preprocessed results from the device B and the device C respectively over the network. A communication module of the device B receives the sound preprocessed result from the device C over the network. A communication module of the device C receives the sound preprocessed result from the device B over the network.

A first sound preprocessed result obtained by the device B based on its own sound acquisition module and sound preprocessing module has a signal quality that exceeded a predetermined threshold. However, the sound quality of the acquired audio signal in the second sound preprocessed result received by the device B which is obtained from the device C over the network is better. According to the sound qualities of the first and second sound preprocessed results, the device B selects the sound preprocessed result with the highest sound quality (i.e., the second sound preprocessed result received from the device C herein) for subsequent speech recognition.

In the scenario shown in FIG. 2, for example, in another case, the signal quality of the first sound preprocessed result obtained by the device B based on its own sound acquisition module and sound preprocessing module has exceeded a predetermined threshold. Even if the quality of the acquired audio signal in the second sound preprocessed result obtained from the device C is better, the device B can still use the preprocessed signal obtained by its own sound acquisition module and sound preprocessing module for subsequent speech recognition.

In the scenario shown in FIG. 2, for example, in another case, it is supposed that the device A is a television, the device B is an air conditioner, and the device C is a desk lamp. The device A, the device B, and the device C can support a part of common instruction information. For example, these three devices all support generic instruction information with an instruction value range of 000-099, such as a wake-up instruction “Hello A”. In addition, the three devices also support different types of instructions. For example, the device A supports instruction information “Raise the TV volume (111)”, while the device B and the device C do not support this instruction.

In the scenario shown in FIG. 2, for example, in another case, the device A can not acquire an audio signal through the sound acquisition module of the device A because the distance from the user exceeds the sound pickup distance. But the device A receives the second sound preprocessed result from the device B and the device C over the network. The device A selects the second sound preprocessed result with the highest sound quality according to the sound quality ranking among the second sound preprocessed results for subsequent speech recognition.

In the scenario shown in FIG. 2, for example, in one case, the device B performs speech recognition to obtain the first speech recognition result as “Hello A”, and identifies a device identifier in the first speech recognition result as the device A. Therefore, the device B forwards this first speech recognition result to other devices in the network (i.e., device A and device C).

In the scenario shown in FIG. 2, for example, in another case, the device A performs speech recognition to obtain the first speech recognition result as “Hello A”, and identifies the device identifier in the first speech recognition result as the device A. Therefore, the device A does not forward the first speech recognition result to other devices in the network.

In the scenario shown in FIG. 2, for example, the device A obtains a first speech recognition result (“Hello A”) based on its own sound processing module. The device A receives a second speech recognition result (“Hello C”) from the device B over the network. The device A receives another second speech recognition result (“Hello A”) from the device C over the network. A weighting process is performed on the three speech recognition results, where the weights are assigned considering two factors, namely, the sound qualities of the recognition results and the source devices of the recognition results. The higher the sound quality, the greater the weight assigned to the corresponding speech recognition result. If the source device of the recognition result is the present device, the weight assigned will be greater. For example, according to the sound quality, the device A in this example assigns different weights (B: 0.6, C: 0.4) to the second speech recognition results received from the device B and the device C respectively, and assigns a higher weight value (A: 0.8) to the first speech recognition result from the device A itself. Therefore, the final weighted result for these three speech recognition results is “Hello A”: 1.2, and “Hello C”: 0.6. And thus, the final speech recognition result is “Hello A”.

In the scenario shown in FIG. 2, for example, the device A determines the time validity of the speech recognition result based on the final speech recognition result (“Hello A”). If it is found to be still within the valid time range, it is further determined whether the device identifier is the present device; and it is found that the device identifier of the speech recognition result is “A”, that is, the present device, therefore the operation corresponding to the instruction information is executed. At the same time, the device A sends feedback information to other devices in the network (i.e., the device B and the device C). The feedback information includes at least a recognition time, a recognition result and a maximum value of the incremental sequence number. The device B and the device C receive the feedback information and are informed that the recognition result has been executed, so the device B and the device C stop the speech recognition operation and the sending operation performed on their own devices respectively.

As shown in FIG. 2, when the user emits an audio signal “Hello A” between the device B and the device C, the device B and the device C will acquire the audio signal of the user through their respective sound acquisition modules. In addition, each of the device B and the device C performs preprocessing on the audio signal by their respective sound processing modules to obtain a sound preprocessed result. Because the distance from the user exceeds the sound pickup distance of the sound acquisition module, the device A and other devices in the network cannot acquire the sound through the device's own sound acquisition module. Wherein, the sound preprocessed result includes a sound feature value, sound quality information, and sound time information. Wherein, the sound feature value is the MFCC feature value or the PLP feature value of the audio signal, that is, the sound feature value obtained by the MFCC algorithm, which is used to represent the content of the speech information. The sound quality information includes a signal-to-noise ratio and an amplitude of the audio signal. The sound time information includes a start time and an end time of the audio signal, or a start time and a duration of the audio signal. The sound preprocessed result also includes an incremental sequence number. Taking device B as an example, the first sound preprocessing data sent can include N data blocks, where each data block has an incremental sequence number. The sound time information can include the start time information and/or the end time information of the audio signal, so as to distinguish different sound information.

As shown in FIG. 2, each of the device B and the device C sends the obtained sound preprocessed result to all devices in the network. The device A receives the sound preprocessed results from the device B and the device C respectively over the network. The device B receives the sound preprocessed result from the device C over the network. The device C receives the sound preprocessed result from the device B over the network. The device A prioritizes the sound preprocessed information received from the device B and the sound preprocessed information received from the device C over the network, so as to select the sound preprocessed result for subsequent speech recognition. The device B prioritizes the sound preprocessed information obtained locally and the sound preprocessed information received from the device C over the network, so as to select the sound preprocessed result for subsequent speech recognition. The device C prioritizes the sound preprocessed information obtained locally and the sound preprocessed information received from the device B over the network, so as to select the sound preprocessed result for subsequent speech recognition.

In another embodiment, the solution of the present disclosure can be applied to a continuous speech recognition scenario. In this scenario, also referring to FIG. 2, suppose that the user walks from the device B to the device C while giving the sound instruction “Turn on the kitchen light”. In this embodiment, the device A is a kitchen light, the sound acquired by the device B is “Turn on the kit-”, and the sound acquired by the device C is “-chen light”.

The device B and the device C preprocess the sound information, and the preprocessed information obtained by the device B corresponds to the feature information of “Turn on the kit-” and the various preprocessing information mentioned above; the preprocessed information obtained by the device C corresponds to the feature information of “-chen light” and the various preprocessed information mentioned above. And both the device B and the device C send their preprocessing information to the group named “Group 1”.

As mentioned above, the preprocessed data may include N data blocks, and each of the N data blocks is provided with an incremental sequence number, and the duration of each data block may be for example 30 ms, and each data block is assigned an incremental sequence number. The incremental sequence number is related to the time point when the device completes the preprocessing. It is generally supposed that if the user issues a speech instruction indoors, the devices (A, B, C) in the network are close in the time points to complete the preprocessing. For different devices, the sequence numbers of the preprocessed data blocks that complete the preprocessing at the same/similar time point (which can actually be of about 10 ms time difference) are the same.

In practice, the device will send each data block to the group after processing each data block. After receiving each data block, the device will select the best data block from those data blocks with the same sequence number (in a way similar to preprocessing ranking), and the data blocks with different sequence numbers are concatenated to form a complete preprocessed result.

For example, the speech instruction “Hello A” can be divided into 10 data blocks (sequence numbers of 000-009) after speech preprocessing, and the device A will: select a data block from multiple received data blocks with a sequence number of 000; select a data block from multiple received data blocks with a sequence number of 001; . . . ; and concatenate the multiple data blocks in order of sequence numbers to form the final preprocessed result (i.e., the first preprocessed result).

This can solve the problem of personnel movement. If the user moves from the vicinity of the device A to the vicinity of the device B during the process of issuing a speech instruction, each device can only acquire part of the speech information. For example, the device A can acquire data blocks with sequence numbers of 000-006, and the device B can acquire data blocks with sequence numbers of 003-009. Through the above method, both the device A and the device B can receive data blocks with sequence numbers of 000-009, so that the concatenation of speech data (i.e., preprocessed result) can be completed.

It should be understood that the above distributed speech recognition system and method are provided as examples only and are not limitations of the present disclosure. Those skilled in the art should understand that the principles of the present disclosure can be applied to systems and methods other than the above-described distributed speech recognition without departing from the scope of the present disclosure. While various embodiments of various aspects of the disclosure have been described for the purpose of the disclosure, it shall not be understood that the teaching of the disclosure is limited to these embodiments. The features disclosed in a specific embodiment are therefore not limited to that embodiment, but can be combined with the features disclosed in different embodiments. For example, one or more features and/or operations of the method according to the present disclosure described in one embodiment can also be applied individually, in combination or as a whole in another embodiment. Descriptions of the system/device embodiments are equally applicable to method embodiments, and vice versa. It can be understood by those skilled in the art that more optional embodiments and variations are possible, and that various changes and modifications can be made to the system described above, without departing from the scope defined by the claims of the present disclosure.

1. A distributed speech processing system, comprising:
a plurality of node devices in a network, wherein each of the plurality of node devices comprises a processor, a memory, a communication module, and a sound processing module, and at least one of the plurality of node devices comprises a sound acquisition module; wherein,
the sound acquisition module is configured to acquire an audio signal;
the sound processing module is configured to preprocess the audio signal to obtain a first sound preprocessed result;
the communication module is configured to send the first sound preprocessed result to one or more node devices in the network;
the communication module is further configured to receive one or more second sound preprocessed results from at least one other node device over the network; and
the sound processing module is further configured to perform speech recognition based on at least one of the first sound preprocessed result and the one or more second sound preprocessed results to obtain a first speech recognition result.

2. The distributed speech processing system according to claim 1, wherein the communication module is further configured to send the first speech recognition result to one or more node devices in the network;
the communication module is further configured to receive one or more second speech recognition results from at least one other node device over the network; and
the sound processing module is further configured to perform speech recognition based on the first speech recognition result and the one or more second speech recognition results to obtain a final speech recognition result.

3. The distributed speech processing system according to claim 1,
wherein each of the first sound preprocessed result and the one or more second sound preprocessed results comprises a sound feature value, a sound quality, and sound time information.

4. The distributed speech processing system according to claim 3,
wherein the sound feature value is an MFCC feature value or a PLP feature value of the audio signal.

5. The distributed speech processing system according to claim 3,
wherein the sound quality comprises a signal-to-noise ratio and an amplitude of the audio signal.

6. The distributed speech processing system according to claim 3, wherein the sound time information comprises one of the following:
a start time and an end time of the audio signal, and
a start time and a duration of the audio signal.

7. The distributed speech processing system according to claim 3,
wherein each of the first sound preprocessed result and the one or more second sound preprocessed results further comprises an incremental sequence number of the audio signal.

8. The distributed speech processing system according to claim 3, wherein for each of the first sound preprocessed result and the one or more second sound preprocessed results, the sound processing module is further configured to:
determine whether a corresponding sound quality exceeds a predetermined threshold, and
in response to that the corresponding sound quality does not exceed the predetermined threshold, discard a corresponding speech preprocessed result.

9. The distributed speech processing system according to claim 3, wherein the sound processing module is further configured to select, among the first sound preprocessed result and the one or more second sound preprocessed results, one or more sound preprocessed results with a highest sound quality to perform speech recognition to obtain the first speech recognition result.

10. The distributed speech processing system according to claim 2, wherein the sound processing module is further configured to perform weighting processing on the first speech recognition result and the one or more second speech recognition results to obtain the final speech recognition result.

11. A distributed sound processing method, implemented by a node device in a network, the method comprising:
in response to that the node device comprises a sound acquisition module, performing the following steps:
acquiring an audio signal;
preprocessing the audio signal to obtain a first sound preprocessed result; and
sending the first sound preprocessed result to one or more node devices in the network;
receiving one or more second sound preprocessed results from at least one other node device over the network; and
performing speech recognition based on at least one of the first sound preprocessed result and/or the one or more second sound preprocessed results to obtain a first speech recognition result.

12. The distributed speech processing method according to claim 11, further comprising:
sending the first speech recognition result to the one or more node devices in the network;
receiving one or more second speech recognition results from at least one other node device over the network; and
performing speech recognition based on the first speech recognition result and the one or more second speech recognition results to obtain a final speech recognition result.

13. The distributed speech processing method according to claim 11, wherein each of the first sound preprocessed result and the one or more second sound preprocessed results comprises a sound feature value, a sound quality and sound time information.

14. The distributed speech processing method according to claim 13, wherein the sound feature value is an MFCC feature value or a PLP feature value of the audio signal.

15. The distributed speech processing method according to claim 13, wherein the sound quality comprises a signal-to-noise ratio and an amplitude of the audio signal.

16. The distributed speech processing method according to claim 13, wherein the sound time information comprises one of the following:
a start time and an end time of the audio signal, and
a start time and a duration of the audio signal.

17. The distributed speech processing method according to claim 13, wherein each of the first sound preprocessed result and the one or more second sound preprocessed results further comprises an incremental sequence number of the audio signal.

18. The distributed speech processing method according to claim 13, for each of the first sound preprocessed result and the one or more second sound preprocessed results, further comprising:
determining whether a corresponding sound quality exceeds a predetermined threshold, and
in response to that the corresponding sound quality does not exceed a predetermined threshold, discarding a corresponding speech preprocessed result.

19. The distributed speech processing method according to claim 13, further comprising: among the first sound preprocessed result and the one or more second sound preprocessed results, selecting one or more sound preprocessed results with a highest sound quality to perform speech recognition to obtain the first speech recognition result.

20. The distributed speech processing method according to claim 12, further comprising: performing weighting processing on the first speech recognition result and the one or more second speech recognition results to obtain the final speech recognition result.
